(19) United States
(12) Patent Application Publication
(10) Pub. No.: US 2011/0170404 A1
(43) Pub. Date: Jul. 14, 2011

(54) MOBILE COMMUNICATION NETWORK

(76) Inventor: Arne Nordin, Djursholm (SE)

(21) Appl. No.: 13/063,238

(22) PCT Filed: Sep. 26, 2008
(86) PCT No.: PCT/SE2008/051080

§ 371 Date: Mar. 10, 2011

(51) Int. Cl. G06F 11/00

(52) U.S. Cl. 370/216

(57) ABSTRACT

The present invention provides a method of operating a first node in a radio communication network to reduce un-expected or undesirable operation of user equipments, the method comprising detecting a fault occurring in the operation of a user equipment that is in communication with said first node; and sending a message to the user equipment indicating an action to be performed to stop or mitigate the fault in said user equipment.

### TECHNICAL FIELD

The present invention generally concerns methods and apparatuses relating to a radio communication network. Specifically, the present invention relates to a reduction in the number of calls being dropped by user equipment that have a fault or faults in their software or hardware.

### BACKGROUND

A user equipment (UE) is any device used directly by an end user to communicate with a network and can comprise any of various models and brands with various software versions. The user equipment can be a hand-held telephone, a card in a laptop computer or another type of device. The user equipment connects to a radio base station (also called “Node-B”), or 3G Base Transceiver Station, as specified in the 25-series of specifications of the Universal Mobile Telecommunications System (UMTS). In a Global System for Mobile communications system (GSM), the radio base station is called a base station transceiver.

The radio interface between the UE and the Node-B is called Uu in a UMTS system, and Um between the UE and radio base station. Further, the Radio Access Network (RAN) here is the general term for GRAN (GSM radio access network), GERAN or GRAN (GERAN essentially the same as GRAN, but specifying the inclusion of EDGE packet radio services access network), or UTRAN (UMTS radio access network). The RAN implements the radio access technology, and conceptually, it sits between the UE, and a core network (CN). A dual mode UE can be connected to a call between different RANs without the end user noticing any disruption in service.

The UE handles Mobility management, Call control, Session management, and Identity management towards the core network. The corresponding protocols are transmitted transparently via a Node-B, that is, the Node-B does not change, use or understand the information. These protocols are also referred to as Non-access stratum (NAS) protocols.

A call that has been established between two end users, with at least one user having a UE (the other user can use, for example, a telephone handset on a public switched telephone network) can be interrupted, and the call dropped, as a result of a certain event or events being triggered due to a fault in the software that operates the UE. A short term solution to such a problem is for the end user to switch the UE off and on.

However, the end user may not be aware that it was a fault in the UE or its software that has caused the call to be dropped, and the end user might not switch the UE off and on as described above. Therefore, the UE may continue to drop calls as the fault condition still exists in the UE. This is particularly an issue for packet switched (PS) calls, as the connection is normally reestablished a number of times in this type of call, which means the number of dropped connections can multiply.

In the prior art, a solution is to manually upgrade the UE software to a version in which the fault is corrected. However, this is a very long term solution for a UE, particularly if a certain model of UE or brand is causing a wide spread problem, not only for the end user of the UE, but also for the service provider, and in many cases the upgrade is never carried out.

### SUMMARY

According to a first aspect of the invention, there is provided a method of operating a first node in a radio communication network to reduce unexpected or undesirable operation of user equipments, the method comprising detecting a fault occurring in the operation of a user equipment that is in communication with said first node; and sending a message to the user equipment indicating an action to be performed to stop or mitigate the fault in said user equipment.

In a preferred embodiment, the action includes at least one of resetting the user equipment, resetting a memory of the user equipment, updating the software version of the user equipment, or switching the user equipment off and on.

In a preferred embodiment, the message indicates whether the action should be performed immediately on receipt or when the user equipment is in an idle mode.

In a preferred embodiment, the step of detecting a fault occurring in the operation of the user equipment comprises examining the interaction between the user equipment and the radio communication network.

Preferably, the step of detecting a fault comprises examining the occurrence of calls being dropped by the user equipment.

In one embodiment, the step of detecting a fault comprises sending a request message to the user equipment and examining the response.

Preferably, the request message comprises one or more of a reconfiguration request, a setup request, a release request and a measurement control message.

In a further embodiment, prior to the step of detecting a fault, the first node examines statistics and/or traces from logs stored in the radio communication network relating to interactions of said user equipments with said radio communication network to identity possible faults of the user equipments.

Preferably, the first node identifies a group of user equipments having a particular fault.

Preferably, the group of user equipments comprises user equipments that are made by the same manufacturer, that are the same model, and/or that use the same software version.

In a particular embodiment, the first node is one of a base station subsystem comprising at least one base transceiver station communicating with said plurality of user equipments, or a radio access network comprising a radio access controller serving at least one node-B that communicates directly with said plurality of user equipments, or an evolved UTRAN node-B that communicates with said plurality of user equipments.

In preferred embodiments, the message indicating an action to be performed to stop or mitigate the fault in said user equipment comprises a layer 3 message or a message provided by a text messaging service.

According to a second aspect, there is provided a method of operating a user equipment to reduce undesired or unexpected operation of the user equipment, the user equipment being adapted to communicate with at least a first node in a radio communication network; the method comprising receiving a message from said first node indicating that a fault has occurred in the operation of said user equipment, the message indicating an action to be performed on or by the user equipment to stop or mitigate the fault in said user equipment.

Preferably, the action includes at least one of resetting the user equipment, resetting a memory of the user equipment, updating the software version of the user equipment, or switching the user equipment off and on.

Preferably, the method further comprises the step of performing the action indicated in the message to correct the fault in the user equipment.

Preferably, the message indicates whether the action should be performed immediately on receipt or when the user equipment is in an idle mode.

According to a third aspect, there is provided a first node adapted to detect a fault occurring in the operation of a user equipment that is communicating with said first node; send a message to the user equipment indicating an action to be performed to stop or mitigate the fault in said user equipment.

According to a fourth aspect, there is provided a user equipment adapted to communicate with a first node in a radio communication network, and adapted to receive a message from said first node indicating that a fault has occurred in the operation of said user equipment, the message indicating an action to be performed on or by the user equipment to stop or mitigate the fault in said user equipment.

According to a fifth aspect, there is provided a method for reducing undesired or unexpected operation of a user equipment in a radio communication network, the radio communication network comprising at least one first node for communicating with a plurality of user equipments; the method comprising detecting a fault occurring in the operation of a user equipment that is in communication with said first node; and sending a message from the first node to the user equipment indicating an action to be performed to stop or mitigate the fault in said user equipment.

A general advantage of the invention is that it reduces the risk of calls being dropped. A user equipment which has a corrupt memory may drop an established connection every time a certain traffic event occurs. For speech calls it is clear that this would be very annoying for the end user. For Packet Switched (PS) calls, the drops can multiply since the connection is normally re-established over and over again in such a scenario.

An advantage of some exemplary embodiments of the invention is that it enables less disturbance in the radio communication network.

An advantage of some exemplary embodiments of the invention is to simplify the procedure of detecting a faulty behaviour of a user equipment.

Still another advantage of some exemplary embodiments of the invention is to improve the procedure of detecting a faulty behaviour of a user equipment by collecting data of fault for a time period and analyzing.

Other objects, advantages and novel features of the invention will become apparent from the following detailed description of the invention when considered in conjunction with the accompanying drawings and claims.

### BRIEF DESCRIPTION OF THE DRAWINGS

The invention will now be described in detail, by way of example only, with reference to the following drawings, in which:

FIG. 1 is a block diagram illustrating a cellular radio communication network in which the present invention may be employed;

FIG. 2 is a flow chart illustrating an exemplary method according to the invention;

FIG. 3 is a flow chart illustrating another exemplary method according to the invention; and

FIG. 4 is a signalling diagram illustrating the operation of a mobile communication network in accordance with the invention.

### DETAILED DESCRIPTION

The present invention is particularly suited for, but is not limited to use in, second generation digital systems, such as for example the European Global System for Mobile communications (GSM) and third generation Public Land Mobile Networks (PLMNs) such as e.g. Universal Mobile Telecommunications Service (UMTS) and CDMA-2000. Thus, although the invention will be described below with reference to a UMTS Terrestrial Radio Access Network (UTRAN), it will be appreciated that the invention is not limited to this type of network.

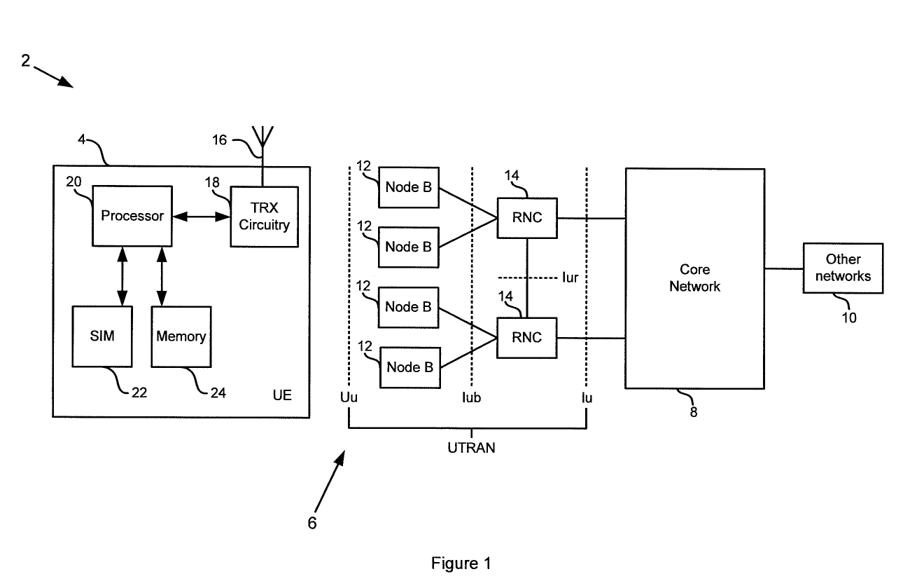

FIG. 1 shows a cellular radio communication network 2 in which the present invention can be employed. In particular, as described above, a user equipment (UE) 4 communicates with a radio access network (UTRAN) 6 over an interface Uu. The radio access network 6 communicates with a core network 8 through an interface lu. The core network 8 is connected to other types of network 10, such as the Internet, PSTNs, PLMNs, ISDNs, etc. As is well known, the radio access network 6 comprises a number of nodes 12, known as Node B's with which the user equipments 4 communicate. The node B's 12 are connected to radio network controllers 14 through lub interfaces.

The user equipment 4 comprises an antenna 16 connected to transceiver circuitry 18, which is itself connected to a processor 20 that controls the operation of the UE 4. The UE 4 also comprises a subscriber identity module (SIM) 22 that includes information identifying the subscriber, such as an IMSI (International Mobile Subscriber Identity), and a memory 24.

The memory 24 stores a variety of information that is used in the operation of the UE 4. For example, the memory 24 can store one or more software programs that are executed to perform various operations in the UE 4 and an IMEI (International Mobile Equipment Identity). Although the memory 24 is shown as a single unit, it will be appreciated that the memory 24 can comprise several different types of memory. For example, the IMEI and software programs can be stored in a read-only memory (ROM) unit, and there can be a random access memory (RAM) unit that is used during the operation of the UE 4.

In accordance with an aspect of the invention, the radio access network 6 or core network 8 detects faulty behaviour by the UE 4 (i.e. where the UE 4 operates unexpectedly or undesirably), and issues a message to the UE 4 that instructs the UE 4 to take action to correct the faulty behaviour.

Thus, the present invention comprises a first exemplary embodiment wherein the RAN 6 is able to detect a faulty behaviour of a UE 4, and a second exemplary embodiment wherein if a faulty behaviour is detected, a message can be sent by the RAN 6 or CN 8 to the UE 4 to instruct the UE 4 to take action to correct the faulty behaviour. For example, the message can instruct the UE 4 to perform a reset, which can include clearing a non-permanent memory 24 in the UE 4.

Therefore, according to the first exemplary embodiment of the invention, the RAN 6 or core network 8 will include new functionality to detect faults in individual UEs 4. The detection can be based on the UE 4 behaviour in the interaction with the RAN 6 over the Uu interface. Specific faults (including the circumstances that cause the fault to arise) can also be identified by the manufacturer or the vendor of a particular user equipment 4.

Faulty behaviour or otherwise unexpected or undesirable operation of the UE 4 can include faulty messages, cause values (which are predefined values used in RRC messages between the UE 4 and RAN 6 to indicate error conditions or reasons for sending the message), dropped calls or any other detectable errors. Faulty messages are where the RAN 6 can detect messages but parameters of the message (such as Information Elements) can be out of range, out of context or simply corrupt (i.e. not possible to decode).

To detect a specific UE 4 fault, it may be necessary for the RAN 6 or CN 8 to investigate and understand how a specific user equipment software version or an individual user equipment misbehaves or otherwise operates undesirably or unexpectedly.

The RAN 6 or CN 8 can use statistics, like counters, events and traces from RAN and UE logs to identify faults in a user equipment 4. As soon as a user equipment 4 behaves unexpectedly or undesirably, the data is logged in the user equipment 4 and/or the RAN 6. This data can include the IMSI, IMEI (International Mobile Equipment Identity) and/or IMEISV (International Mobile Equipment Identity and Software Version). The logging of statistics can be done for a time period, and stored in a local storage or memory unit.

By analyzing the data that has been collected for a selected time period for one or more user equipments 4, it is possible to identify certain individual user equipments 4 that are, or can be, faulty, or a group of user equipments that are, or can be, faulty.

The group of user equipments 4 may be, for example, a certain model of user equipment, all models from a particular manufacturer or vendor, and/or user equipments with a certain software version. The software version of a particular user equipment 4 can be identified from the IMEISV that is stored in the user equipment 4 and is transmitted in some messages between the user equipment 4 and core network 8.

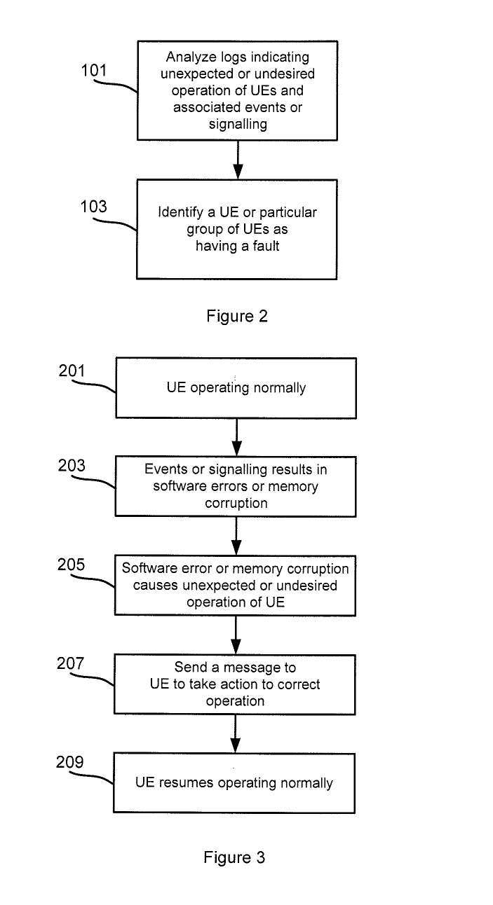

A method in accordance with the first exemplary embodiment is shown in FIG. 2. In step 101, the RAN 6 or CN 8 analyses logs or other statistics that indicate unexpected or undesirable operation of one or more user equipments 4, and optionally, the associated events or signaling that led to the unexpected or undesirable operation.

In step 103, the RAN 6 or CN 8 as appropriate identifies a user equipment 4 or group of user equipments 4 as having a fault. The RAN 6 or CN 8 as appropriate stores the identities of the user equipment (for example in the form of an IMEI) or an identity of the model or manufacturer (for example as given by part of the IMEI) having the fault, and optionally additional information connected to the fault, such as the signaling or events that preceded the fault.

In accordance with a second exemplary embodiment of the invention, a message can be sent from the RAN 6 or CN 8 to the UE 4 to instruct the UE 4 to take some action in response to the fault that has occurred in the UE 4. In preferred embodiments, this message instructs the UE 4 to reset or clear relevant parts of the memory 24 (such as a RAM), or to perform a full reset of the UE 4. In alternative embodiments, the message can request the user of the UE 4 to switch the UE 4 off and on, or to update the software in the UE 4. In further alternative embodiments, a software update can be provided direct to the UE 4 from the core network 8. In preferred embodiments, the message can indicate whether the action should be taken immediately by the UE 4 or user, or whether the UE 4 should wait until it is in an idle mode. In preferred embodiments, the message is a layer 3 message (for example a RRC message in a 3GPP network). In alternative embodiments, the message can be provided by a text messaging service, such as SMS, particularly if the action is to be taken by a user of the UE 4.

FIG. 3 is a flow chart illustrating an exemplary embodiment of the invention. In step 201, the UE 4 is operating normally (i.e. as expected). In step 203, certain events or signaling results in a software error or memory corruption occurring in the UE 4. These certain events or signaling may be normal events or signaling within the network, but which result in software errors or memory corruption in the UE 4 as a result of problems with the software running on the UE 4.

In step 205, the software error or memory corruption causes unexpected or undesired operation of the UE 4. This undesired or unexpected operation could occur as soon as the error or corruption occurs, or it could manifest itself later, during a subsequent call, say.

The RAN 6 or CN 8 can detect this undesired or unexpected operation by observing the dropping of calls by the UE 4, or as a result of receiving a failure message from the UE 4 in response to one or more messages being sent to the UE 4 by the RAN 6 or CN 8. These messages can include a reconfiguration request message, a setup request message, or a release request message.

The RAN 6 or CN 8 can also use the information collected using the method shown in FIG. 2 to assist in detecting the undesired or unexpected operation of a UE 4. As described above, this information can indicate the circumstances that lead to faults in particular UEs 4, as well as the behaviour of the UEs 4 after these faults occur.

Once this fault is detected and identified by the RAN 6 or CN 8, the RAN 6 or CN 8 can generate a message for the UE 4 that instructs the UE 4 to take action to correct the faulty behaviour (step 207). As described above, this action can be a memory reset, a full reset of the UE 4, or an instruction to the user of the UE 4 to switch the UE off and back on again, or to obtain a software update for the UE 4.

Once the specified action has been taken by the UE 4 or the user of the UE 4, the UE 4 resumes operating normally (step 209).

Of course, it will be appreciated that if the remedial action does not involve an update of the software in the UE 4 that initially generated the fault, the UE 4 may experience the fault again, if the particular events or signaling reoccur.

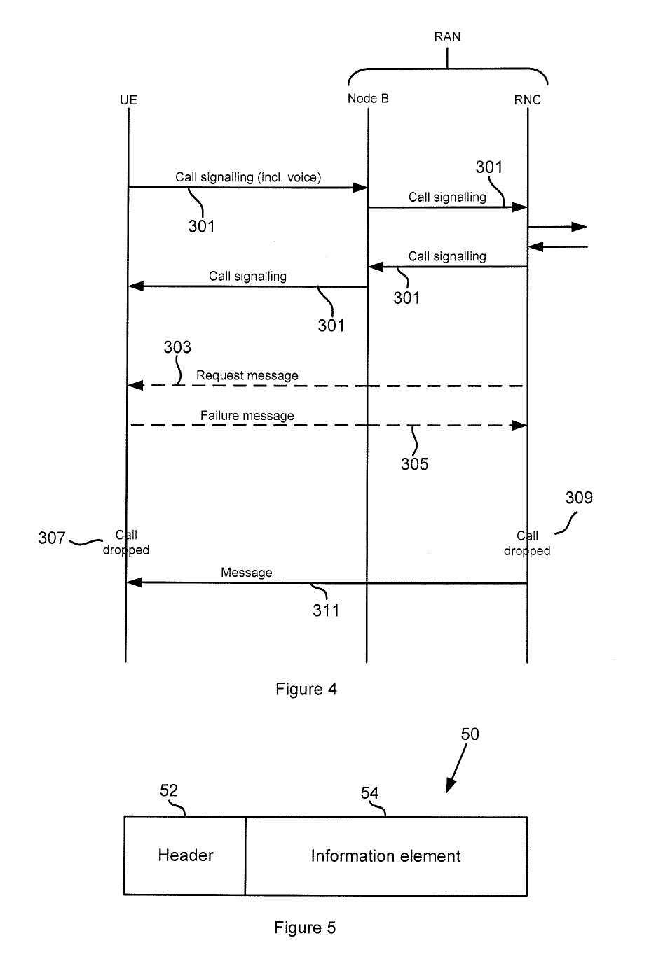

FIG. 4 is a diagram illustrating the signaling that occurs in the network in accordance with the invention. Thus, the UE 4 can be involved in a call, which requires various call signaling 301 to be sent from the UE 4 to the Node B 12 in the RAN 6, and from the Node B 12 to the UE 4. This signaling is conventional and will not be described further herein.

The RNC 14 can send a request message 303 to the UE 4 as described above, which can be, for example, a reconfiguration request, a setup request, a release request or a measurement control request. As the UE 4 replies with a failure message 305 (or alternatively no message or a message that contains errors or is out of context), the RNC 14 can determine that the UE 4 has a fault.

Due to the fault in the UE 4, the call, or a subsequent call, is dropped, as indicated by 307 and 309. For example, the call may be dropped if the RAN 6 orders a reconfiguration of the connection and the UE 4 fails to respond, or responds out of context. This signaling occurs between the UE 4 and RNC 14 with the Node B 12 relaying the signaling transparently.

Therefore, the RNC 14 sends a message 311 to the UE 4 instructing the UE to take some action to fix the fault.

FIG. 5 shows an exemplary message that can be sent from the RAN 6 or CN 8 to the UE 4 in order to instruct the UE 4 or user of the UE 4 to take some action to remedy the fault. The message 50 can comprise a header 52 and an information element 54. The information element 54 can include a field that indicates to the UE 4 the action to be taken to fix the fault. For example, the field can indicate that the UE should reset or clear a memory, perform a full reset, display a message to the user of the UE 4 to request the user to switch the UE 4 off and back on again, or download a software update. Furthermore, the information element 54 can include a field that indicates whether the action should be taken immediately, or when the UE 4 is in an idle mode.

There is therefore provided a method by which unexpected or undesired operation of user equipments in a communication network can be reduced.

The methods described here are purely illustrative examples for understanding the invention and many modifications are possible, e.g. some steps/actions may be effectuated in a different/reverse order giving the same result, as a person skilled in the art realizes.

1. A method of operating a first node in a radio communication network to reduce unexpected or undesirable operation of user equipments, the method comprising:
detecting a fault occurring in the operation of a user equipment that is in communication with said first node; and
sending a message to the user equipment indicating an action to be performed to stop or mitigate the fault in said user equipment.

2. The method according to claim 1, wherein said action includes at least one of the following:
resetting the user equipment, resetting a memory of the user equipment, updating the software version of the user equipment, or switching the user equipment off and on.

3. The method according to claim 1 or 2, wherein the message indicates whether the action should be performed immediately on receipt or when the user equipment is in an idle mode.

4. The method according to claim 1, 2 or 3, wherein the step of detecting a fault occurring in the operation of the user equipment comprises examining the interaction between the user equipment and the radio communication network.

5. The method according to claim 4, wherein the step of detecting a fault comprises sending a request message to the user equipment and examining the response.

6. The method according to any of claims 1 to 5, wherein prior to the step of detecting a fault, the first node examines statistics and/or traces from logs stored in the radio communication network relating to interactions of said user equipments with said radio communication network to identity possible faults of the user equipments.

7. The method according to claim 6, wherein the first node identifies a group of user equipments having a particular fault.

8. A method of operating a user equipment to reduce undesired or unexpected operation of the user equipment, the user equipment being adapted to communicate with at least a first node in a radio communication network; the method comprising:
receiving a message from said first node indicating that a fault has occurred in the operation of said user equipment, the message indicating an action to be performed on or by the user equipment to stop or mitigate the fault in said user equipment.

9. A first node adapted to:
detect a fault occurring in the operation of a user equipment that is communicating with said first node;
send a message to the user equipment indicating an action to be performed to stop or mitigate the fault in said user equipment.

10. The first node according to claim 9, wherein said action includes at least one of the following:
a reset of the user equipment, a reset of a memory of the user equipment, an update of the software version of the user equipment, or switching the user equipment off and on.

11. The first node according to claim 9 or 10, wherein the message contains an indication of whether the action should be performed immediately on receipt or when the user equipment is in an idle mode.

12. The first node according to claim 9, 10 or 11, wherein the first node is adapted to detect a fault occurring in the operation of the user equipment by examining the interaction between the user equipment and the radio communication network.

13. The first node according to claim 12, wherein the first node is adapted to detect a fault by sending a request message to the user equipment and examining the response.

14. The first node according to any of claims 9 to 13, wherein the first node is further adapted to examine statistics and/or traces from logs stored in the radio communication network relating to interactions of said user equipments with said radio communication network to identity possible faults of the user equipments.

15. The first node according to claim 14, wherein the first node is adapted to identify a group of user equipments having a particular fault.

16. The first node according to any of claims 9 to 15, wherein the first node is one of a base station subsystem comprising at least one base transceiver station communicating with said plurality of user equipments, or a radio access network comprising a radio access controller serving at least one node-B that communicates directly with said plurality of user equipments, or an evolved UTRAN node-B that communicates with said plurality of user equipments.

17. A user equipment adapted to communicate with a first node in a radio communication network, and adapted to receive a message from said first node indicating that a fault has occurred in the operation of said user equipment, the message indicating an action to be performed on or by the user equipment to stop or mitigate the fault in said user equipment.

18. A method for reducing undesired or unexpected operation of a user equipment in a radio communication network, the radio communication network comprising at least one first node for communicating with a plurality of user equipments; the method comprising:
detecting a fault occurring in the operation of a user equipment that is in communication with said first node; and
sending a message from the first node to the user equipment indicating an action to be performed to stop or mitigate the fault in said user equipment.
